(19) United States
(12) Patent Application Publication
(10) Pub. No.: US 2007/0065215 A1
(43) Pub. Date: Mar. 22, 2007

(54) Display-equipped key,key assembly, device and method

(76) Inventor: Ronald Brown, Morgan Hills, CA (US)

Correspondence Address: David D. Stein;Boyle, Fredrickson, Newholm, Stein & Gratz, S.C., Suite 1030, 250 East Wisconsin Avenue, Milwaukee, WI, 53202, US

(21) Appl. No.: 11/406,948

(22) Filed: Apr. 18, 2006

Related U.S. Application Data
(60) Provisional application No. 60/672,832, filed on Apr. 18, 2005.

(51) Int. Cl. B41J 5/00

(52) U.S. Cl. 400/490

(57) ABSTRACT

A display key, data input device and related methods with the display key formed of a plurality of snap-together components housing a display therein which is dynamically configurable. At least one of the components includes an integral seat that orients and can also locate the display relative to a key top ensuring it can be viewed. A preferred display key assembly includes onboard display driver circuitry that seats in an integral seat of a key base having a conventional plunger and which is of snap fit construction of a keycap having at least a portion of which being translucent or transparent to permit an image generated by the display to be viewed by a user of a processing unit controlled by the display key equipped data input device.

### CROSS REFERENCE TO RELATED APPLICATION

This application claims priority under 35 U.S.C. Section 119(e) to U.S. Provisional Application Ser. No. 60/672,832, filed Apr. 18, 2005, the entirety of which is hereby expressly incorporated herein by reference.

### FIELD OF THE INVENTION

The present invention is directed to a display-equipped data entry key, a display-equipped key assembly, a display keyswitch assembly, a data entry device equipped with at least a plurality of display-equipped keys, and methods of use and operation of such display-equipped keys and display key equipped devices.

### BACKGROUND OF THE INVENTION

While display-equipped data entry keys have been used in devices such as calculators, computer keyboards, point-of-sale operator keyboards, e.g., cash registers, telephones, custom consoles, e.g., video servers, avionics, and the like, to date the display-equipped data entry keys used in these devices have been costly, many times bulky, and not easily adaptable for devices like keyboards, cell phones, game consoles, and the like without requiring substantial redesign. This is because all presently known commercially available display-equipped keyswitch assemblies are proprietary, which forces the device designer to modify their device to accommodate the particular display-equipped keyswitch assembly of interest.

What is needed is a display-equipped keyswitch assembly that is well suited for use with existing keyswitch using devices with a minimum of modification. What is also needed is a display-equipped keyswitch assembly that is of simple, economical and compact construction enabling such a display-equipped keyswitch assembly to be used in relatively small-footprint applications where compactness is a necessity.

### SUMMARY OF THE INVENTION

The present invention is directed to a display-equipped key assembly well suited for use in a wide variety of processing devices, such as computers, mobile phones, game consoles, and the like, in which the display key housing is of multi-component snap together construction. In a preferred embodiment, the housing is formed by a display keycap configured to facilitate image viewing from an image generated by a display, such as an LCD display or the like, that is captive within the display key assembly. The display keycap mates with a key base having an integral key switch actuating plunger that preferably is of conventional plunger construction for enabling a display key constructed from a display key assembly in accordance with the invention to be used with existing key switch designs. The keycap and base preferably are configured so as to snap together around the display while including onboard integral structure that helps orient and/or locate the display.

In one preferred embodiment, the base includes an integral cradle in which display components seat within the housing formed from assembly of the keycap and base. In a preferred embodiment, the keycap and base include integrally formed interlocking engagement structure enabling them to snap together to form a display key assembly that is of simple, economical, durable and robust construction. In one preferred embodiment one or both the keycap and base have snaps, such as preferably cantilever snaps, that engage via a snap fit to positively assemble the components together to form a display key. In another preferred embodiment, a plurality of integral tabs of the keycap or base are received in complementary tab-receiving pockets formed in the base or keycap enabling the keycap and base to be snapped together.

In a preferred embodiment, the display key assembly includes onboard circuitry including one or more of a display driver, display controller, transducer, backlight or another component that is retained along with the display captive between the keycap and base when the keycap and based are assembled. In one preferred embodiment, an integral seat formed in the base receives a circuit board carrying one of the driver, controller, transducer or backlight with the seat locating the circuit board and display within the display key assembly formed by engaging the keycap with the base. A cable, preferably a ribbon cable, extends from a display module to the onboard circuit board. A second cable preferably extends from the circuit board to an off-board controller, e.g., controller circuit board, of the data input device or the processing device to which the data input device is linked.

In one preferred embodiment, power and data are delivered from the controller board to the display via integrally disposed conductors carried by or integral with the plunger. In a preferred controller arrangement, key display image data is sequentially communicated via a bus connecting all of the display keys of a display key equipped data input device such that display image data order determines which display key displays which image data.

Objects, features and advantages include at least one of the following: providing a display key, data input device and device controlled thereby that is simple to implement, quick, labor-efficient, economical, and which requires relatively simple skills to perform.

Various features and advantages of the present invention will also be made apparent from the following detailed description and the drawings.

### BRIEF DESCRIPTION OF THE DRAWINGS

Preferred exemplary embodiments of the invention are illustrated in the accompanying drawings in which like reference numerals represent like parts throughout and in which:

FIG. 1 is a perspective view of a display key equipped personal computer keyboard of the invention connected to a personal computer;

FIG. 2 is top plan view of the display keyboard of FIG. 1;

FIG. 3 is an enlarged fragmentary perspective view of a display key equipped keyboard or keypad with an image displayed on each display key;

FIG. 4 is an enlarged fragmentary perspective view of a display key with a text message displayed on its key display;

FIG. 5 is a top plan view of another display key displaying an advertising or promotion related image;

FIG. 6 is a perspective view of a display keycap of another preferred display key embodiment depicting changeable text in its key display;

FIG. 7 is an exploded cross sectional side elevation view of a first preferred snap-together display key assembly embodiment;

FIG. 8 is an exploded cross sectional side elevation view of a second preferred snap-together display key assembly embodiment;

FIG. 9 is an exploded cross sectional front elevation view of a third preferred snap-together display key assembly embodiment;

FIG. 10 is a front cross sectional elevation view of the display key assembly embodiment depicted in FIG. 9;

FIG. 11 is a side elevation view of a display keyboard with part of its housing broken away for clarity to show mounting and construction of a display key and key switch assembly;

FIG. 12 is a front cross sectional elevation view of the display key and key switch assembly embodiment depicted in FIG. 11 in a different mounting arrangement;

FIG. 13 is a perspective view of a fourth preferred display key assembly embodiment taken of the left-front side of the display key assembly;

FIG. 14 is a perspective view of a fourth preferred display key assembly embodiment taken of the left-rear side of the display key assembly with its internal components of its display assembly shown in phantom;

FIG. 15 is a front cross sectional elevation view of the display key assembly embodiment shown in FIGS. 13 and 14;

FIG. 16 is a front perspective view of a display key base of the display key assembly embodiment shown in FIGS. 13-15;

FIG. 17 is an exploded perspective view of the display key assembly shown in FIGS. 13-15;

FIG. 18 is an exploded perspective view of a second preferred display key base embodiment and display signal carrying cable-eliminating contact and key switch arrangement; and

FIG. 19 is a schematic of a preferred data input device controller arrangement.

Before explaining one or more embodiments of the invention depicted by the above-identified drawings in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION OF AT LEAST ONE PREFERRED EMBODIMENT

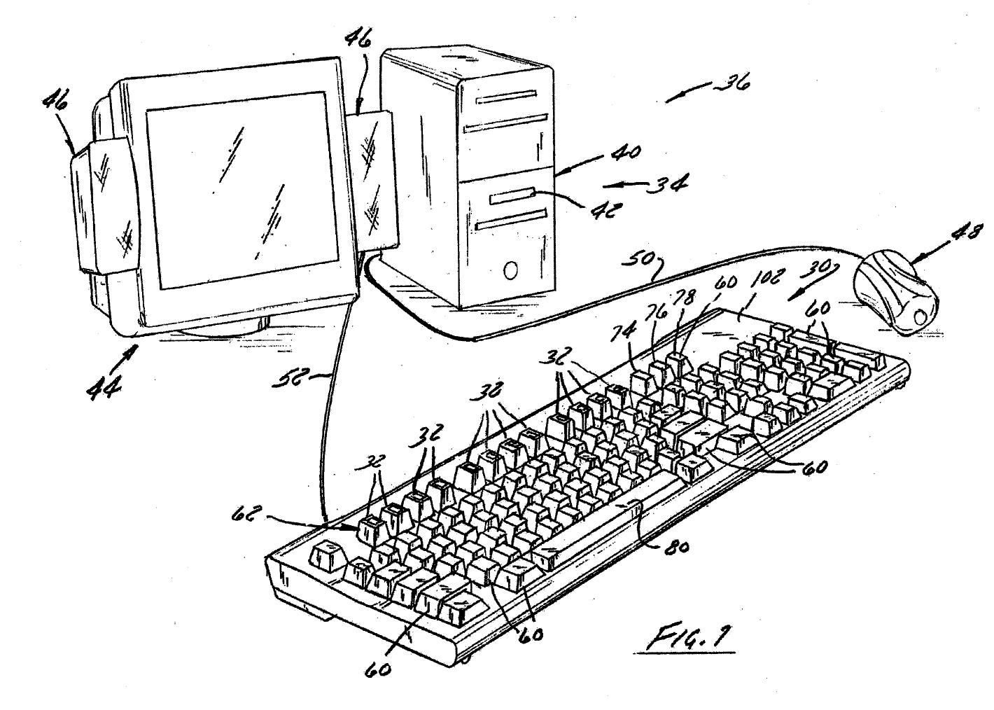

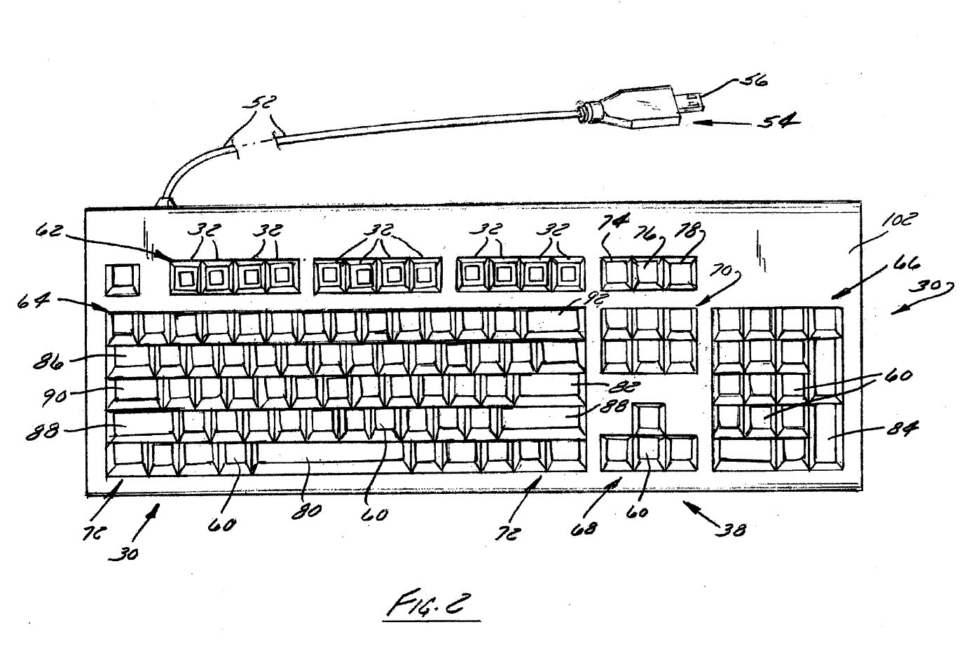

FIGS. 1 and 2 illustrate a preferred embodiment of a manually usable data input device 30 that is equipped with a plurality of pairs (e.g., three or more) of display-equipped data entry keys 32, hereinafter referred to as display keys, which is linked to a data processing device 34, such as preferably a personal computer 36. The data input device 30 depicted in FIG. 1 is a display key equipped keyboard 38, hereinafter referred to as a display keyboard, which preferably is a computer keyboard for a personal computer 36.

As is shown in FIG. 1, the computer 36 has a case 40, such as a tower, which houses a power supply, a motherboard, a processor, e.g., at least one microprocessor, one or more memory storage units, such as random access memory, a disk drive 42, a hard drive, and the like, a video processor, a sound processor and other components. To display information, graphics and the like to a user of the computer 36, a computer monitor 44, such as a CRT equipped with a display screen 58, is linked by a video cable to a video output carried by the computer case 40. To enable sound output, a set of speakers 46 can be linked by another cable to an audio output that is also carried by the computer case 40.

Additional data input devices can be linked to the personal computer 36. For example, as is shown in FIG. 1, a mouse 48 can be linked by a cable 50 or the like to receptacle or socket carried by the computer case 40. While a cable 50 is used to connect the mouse 48 to the computer 36, the mouse 48 can also be wirelessly linked to the computer 36 if desired. Although not shown in the drawings, other input devices, such as a track ball, game console, joystick, touch sensitive tablet, or the like, can also be connected to the computer 36 if desired.

The display keyboard 38 preferably is linked by a cable 52 to the computer 36. As is shown in FIG. 2, the cable 52 has a connector 54 at its free end that is releasably receivable in a socket or receptacle carried by the computer case 40. In a preferred embodiment, the connector 54 used to link the display keyboard 38 to the computer 36 is a USB type A male connector plug 56. While a cable 52 preferably is used to connect the display keyboard 38 to the computer 36, the display keyboard 38 can also be wirelessly linked to the computer 36 if desired. In a preferred embodiment, linking the display keyboard 38 to the computer 36 establishes a high-speed bidirectional digital data link between the display keyboard 38 and computer 36 that preferably enables data transfer at a data transfer rate of at least 12 MB/s such that where a USB serial link is employed it preferably at least complies with USB specification 1.1 or higher.

In a presently preferred display keyboard embodiment depicted in FIGS. 1 and 2, the display keyboard 38 is equipped with at least a plurality of pairs of display keys 32 and at least a plurality of pairs of keys 60 that are not equipped with any display. In the preferred embodiment of the display keyboard 38 shown in FIGS. 1 and 2, the display keyboard 38 has at least a plurality of display keys 32 disposed in a row or column, a plurality of pairs of rows of keys and a plurality of pairs of columns of keys, which can be somewhat staggered such as where the display keyboard 38 implements a QWERTY style layout. While a display key 32 and display keyboard 38 in accordance with the invention is well suited for use with QUWERTY style keyboard layouts, such display keys 32 and display keyboard 38 can also be configured with different layouts, such as the Dvorak layout, MACINTOSH, etc., if desired.

With specific reference to FIG. 2, the display keyboard 38 includes a set of changeable function keys 62 along the top, each of which preferably is a display key 32 according to the invention such that each function key preferably is dynamically reconfigurable in use and operation. Each such display-equipped function key can be user changeable, computer changeable, network changeable or even Internet changeable, depending on the configuration of the processing device 34 to which the display keyboard 38 is linked as well as the configuration of the display keyboard 38 itself. In a preferred embodiment, including as discussed in more detail below, one or more display-equipped function keys are user changeable, e.g., image and/or function programmable, computer changeable, e.g., image and function changeable and/or programmable, network changeable, e.g., image and/or function changeable and programmable, and/or even Internet changeable, e.g., image and function changeable and/or programmable, depending on the configuration of the processing device 34 to which the display keyboard 38 is linked as well as the configuration of the display keyboard 38 itself.

The display keyboard 38 preferably also has a set of alphanumeric keys 64 just below the function keys 62, can have a set of keys to one side that defines a keypad 66, can be equipped with a set of cursor movement keys 68 along with a set of editing keys 70 both of which are located between the alphanumeric keys 64 and the keypad 66, and preferably includes a set of advanced computer operation control keys 72. Particularly where configured for a personal computer 36 or the like, the display keyboard 38 preferably is equipped with at least one spacebar 80, at least one Return key 82 and/or Enter key 84, at least one Tab key 86, at least one Shift key 88, at least one Caps Lock or Shift Lock key 90, and at least one Backspace key 92.

The set of dynamically reconfigurable function display keys 62 preferably includes at least a plurality of pairs of display keys 32. In a preferred embodiment where the keyboard is a display keyboard 38 for a personal computer or the like, at least ten Function keys are display keys 32 and the display keyboard 38 can have as many as fifteen such display keys 32, such as where the display keyboard 38 is intended for use with a MACINTOSH computer. For example, where a display keyboard 38 of the type shown in FIG. 2 is configured for an APPLE or MACINTOSH personal computer, the rightmost three keys 74, 76 and 78 located in the same row as the rest of the function keys 62 can also be display keys 32 (not shown in FIG. 1 or 2).

In a currently preferred embodiment, a display keyboard 38 constructed in accordance with the invention is configured for an IBM-type personal computer 36 and has twelve Function keys that are each dynamically reconfigurable display keys 32. The three non-display keys 74, 76 and 78 to the right of the row of function keys 62 respectively can be a Print Screen/SysRq key 74, a Scroll Lock key 76, and a Pause/Break key 78.

The set of alphanumeric keys 64 includes at least a plurality of pairs of number keys and at least a plurality of pairs of letter keys. While the present invention contemplates a display keyboard where each alphanumeric key can be of dynamically reconfigurable display key construction, the presently preferred display keyboard embodiment depicted in FIGS. 1 and 2 has no dynamically reconfigurable display keys located where the alphanumeric keys are normally located. It should also be noted that a display keyboard constructed in accordance with the invention is well suited for use with keyboards of any language, including English, Chinese, Japanese, Russian (Cyrillic), Turkish, Arabic, and other languages with or without being equipped with display keys 32 as dynamically reconfigurable alphanumeric and/or language changeable keys.

Where equipped with a keypad, the keypad 66 preferably includes number keys ranging from 0-9 along with /, *, −, + and Enter keys with the number keys capable of changing their function to that of one of the cursor movement keys 68 or editing keys 70. The set of cursor movement keys 68 preferably can include an arrow key for each of the four basic directions of cursor movement. The set of editing keys 70 preferably can include an Insert key, a Home key, a Page Up key, a Delete key, an End key and a Page Down key. The set of advanced computer operation keys includes a Crtl key, a WINDOWS or APPLE key, an Alt key, menu activation key(s), along with perhaps a few other keys the function or purpose of which can depend on the type of computer for which the display keyboard 38 is intended, the key layout, and other factors.

FIGS. 3-5 illustrate use and operation of another display key equipped input device 30′, e.g., a digital data input device, which is equipped with a plurality of display keys 32 constructed in accordance with the present invention. As is shown in FIG. 3, the input device 30′ can also be equipped with a plurality of pairs of non-display keys of a configuration similar to or same as the non-display personal computer keyboard keys 60 illustrated in FIGS. 1 and 2.

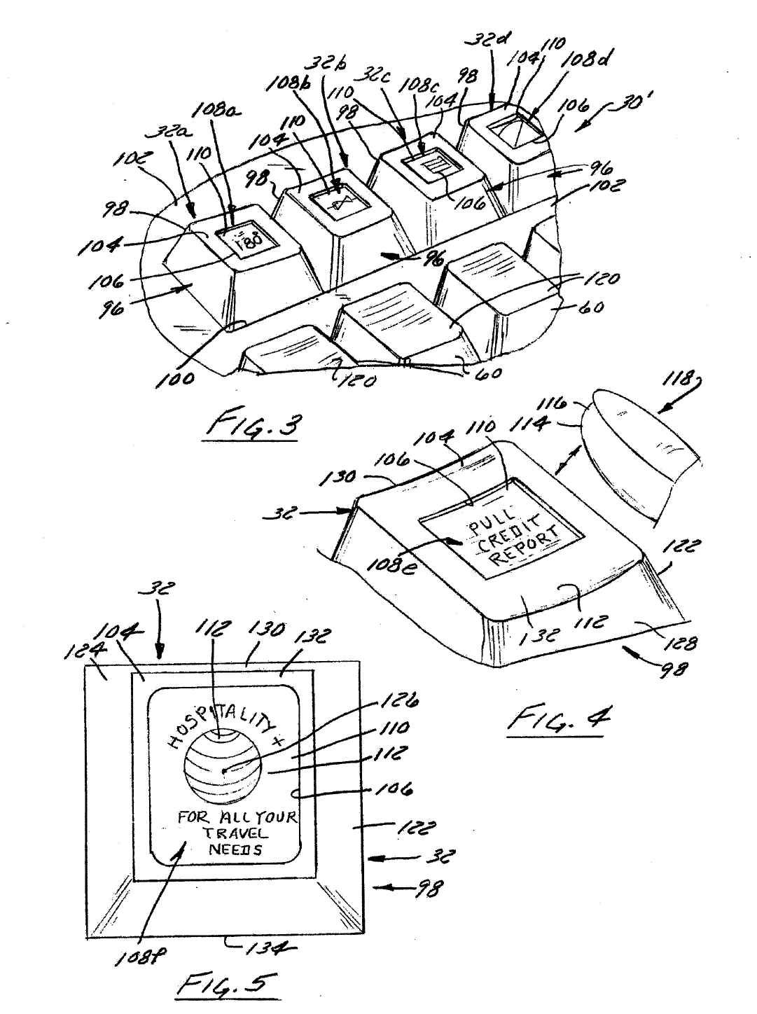

Each display key 32 has an outer housing 96, at least part of which defines a display keycap 98 that projects upwardly from a slot or channel 100 formed in a housing 102 of the input device 30′. The display keycap 98 of each display key 32 has a top surface or wall 104 that includes a generally centrally located window or aperture 106 that is transparent enough that a user of the input device can view an image 108a-108f shown on a display 110 located inside the display keycap 98. As is shown more clearly in FIG. 4, the top wall 104 of the display keycap 98 has a curvilinear concave contour 112 so as to better conform to the convex curved outer surface 114 of a tip 116 of a finger 118 of a user (not shown) pressing the display key 32 with the display keycap top wall 104 preferably having a concave exterior surface shape that is substantially the same as the concave exterior contoured outer surface 120 of at least a plurality of adjacent non-display keys 60 (FIG. 3).

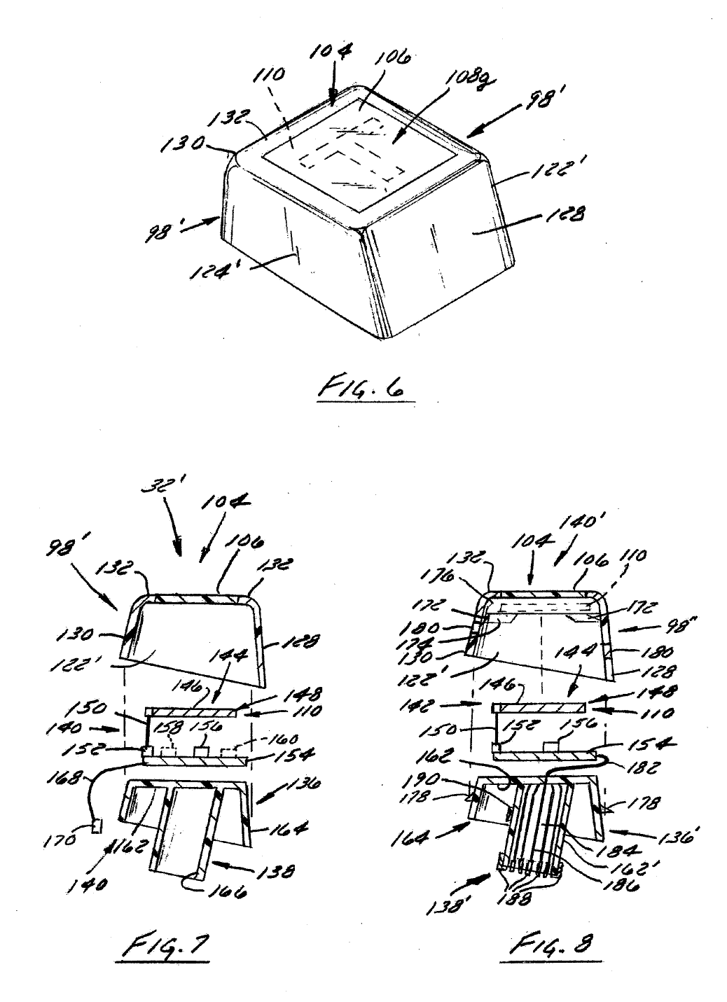

As is shown in more detail in FIG. 5, the display keycap housing 96 of each display key 32 has a pair of spaced apart sidewalls 122 and 124 extending along a longitudinal direction relative to the key 32 with both sidewalls 122 and 124 being inclined so as to converge generally toward one another at an acute angle relative to a central axis of displacement 126 of the display keycap 98 along which the display keycap 98 generally travels when displaced when the display keycap 98 is pressed down by a user (not shown). This central key displacement axis 126 is shown in FIG. 5 as a small round dot that represents an imaginary axis that extends perpendicular to the outer surface of the display keycap window 106 or key display 110. In a preferred embodiment, each display keycap sidewall 122 and 124 is inclined at an acute angle of no greater 30° relative to the central key displacement axis 126 and preferably at an angle no greater than about 20° relative to the axis 126.

The display keycap housing 96 also has a front wall 128 and a rear wall 130 with at least one of the front wall 128 and rear wall 130 having a similar magnitude of angular inclination relative to the central key displacement axis 126 as the sidewalls 122 and 124. Both display keycap housing walls 128 and 130 are generally perpendicularly oriented relative to the sidewalls 122 and 124. In the preferred display key embodiment shown in FIG. 5, the front wall 128 of the display keycap housing 96 generally will be the wall 128 of the display keycap housing 96 situated closest to a user (not shown) pressing down on the corresponding display key 32. In this same preferred embodiment, the front wall 128 preferably is inwardly inclined toward the rear wall 130 such that it has an angle of inclination relative to axis 126 that preferably is no greater than 30°. Preferably, the angle is no greater than about 20°. In a preferred embodiment, both sidewalls 122 and 124 preferably are acutely angled relative to the central key displacement axis 126 at substantially the same angle with their angles of inclination preferably deviating from being the same by no more than 5°. The same preferably is also true with regard to the front wall 128. To the extent the rear wall 130 is inclined at all toward the front wall 128; it preferably is inclined no more than 10° and preferably not more than about 5° relative to the axis 126.

The display keycap 98 is shown in FIGS. 3-5 as having relatively optically opaque walls 122, 124, 128 and 130 along with a relatively opaque inwardly turned lip 132 of the display keycap top wall 104 that defines the periphery of the display keycap window or aperture 106. The lip 132 of the display keycap 32 is narrower in FIG. 5 than in FIG. 4 for increasing window surface are which in turn increases the surface area of the display 110 that is viewable by a user. Such an opaque display keycap design can advantageously be made of an economical synthetic material that is lightweight, tough and yet crack resistant. One preferred material from which a display keycap in accordance with the present invention can be molded is plastic, such as ABS, polystyrene or another suitable plastic. Where the window 106 is defined by an absence of material, such a display keycap 98 in accordance with the invention can be molded such that the window 106 is created substantially simultaneously during molding. Where the window 106 is made of a translucent or transparent material and the rest of the display keycap made of an opaque material, a molding process that accommodates molding the window in place during molding of the display keycap 98.

In another preferred embodiment, the display keycap 98 is made of a translucent material that preferably is substantially clear or transparent. Examples of suitable plastics from which such a display keycap can be molded include polycarbonate, styrene, and acrylic materials. Where the display keycap 98 is made of such a see-through material, the window or aperture 106 can be eliminated or molded with the rest of the display keycap 98 if transparent enough. Where constructed in this manner, a display 110 having a larger viewable surface area that is substantially the same as the surface area of the display keycap top wall 104 can be used which advantageously increases displayed image, character, icon and symbol size thereby improving display readability.

As a result, a display key 32 constructed in accordance with the invention can be made economically and durably while still being able to be made small enough to be substituted for conventional personal computer keyboard non-display keys. For example, where configured for personal computer keyboard use, a display key 32 constructed in accordance with the invention preferably has a height and width no less than 16 millimeters (about 0.63 inch) and no greater than 19 millimeters (about 0.75 inch). Since at least the sidewalls 122 and 124 as well as preferably the front wall and/or the rear wall taper inwardly toward each other as they extend upwardly from the bottom 134 (FIG. 5) of the display keycap 98, the display keycap top wall 104 is smaller in size than its bottom 134.

In a preferred embodiment, each one of the display keys 32 preferably is of substantially the same size as adjacent alphanumeric non-display keys 60. In a preferred embodiment, the window 106 in the display keycap top wall 104 and/or the display 110 of the preferred embodiment depicted in FIG. 5 has a height no greater than about 12.87 mm (about 0.50 inch) and a width no greater than about 10.87 mm (about 0.43 inch). In another preferred embodiment, the height is at least 6 mm (about 0.24 inch) and no greater than 14 mm (about 0.55 inch) and a width of at least 6 mm (about 0.24 inch) and no greater than 12 mm (about 0.47 inch). For example, referring to FIG. 14, the window/display has a height of about 6 mm (about 0.24 inch) and a width of about 8 mm (about 0.31 inch) within a range of ±1 mm (about 39 mils). Such a novel display key construction advantageously enables it to be used with little or no mechanical design modification of existing conventional personal computer keyboards, including those of conventional and small form factors. In addition, such a novel display key construction also enables its use in notebook computer keyboards where rather stringent and tight packaging constraints exist.

As a result, a display key 32 constructed in accordance with the invention requires little to no training because of its intuitive and easy to grasp reconfigurable key display interface that helps facilitate more efficient input device use. This also translates into increased worker productivity, reduced training time and costs, as well as more efficient data processing device use. For example, a display keyboard or display keypad employing display keys constructed in accordance with the present invention is well suited not just for computer and game console gaming applications, it is also well suited for use in call centers, manufacturing and process control rooms and monitoring applications, as well as for advertising and client reward programs.

Where used in call centers, such display keyboards in combination with computer workstations can be used to help more efficiently, quickly and seamlessly enable a customer service assistant to serve many more clients than at present. For example, workstation software can quickly and seamlessly change the images being displayed on the display keys based on the customer and phone number as well as based on the client for whom the call is being handled. Given the rapid and increasingly widespread adoption of IP telephony, such software can be executed on personal computers, IP telephones and/or the IP telephony system, e.g. PBX, to help provide a more productive and advantageous calling experience for the IP telephony user.

For example, where the processing device 34, e.g., computer or the like, is configured for telemarketing or another type of call center task, a call coming in or being made related to a prospective mortgagor or mortgage refinance candidate causes software or firmware to be executed, preferably by the processing device 34, that causes the display of at least a plurality of the display keys to show a corresponding plurality of related tasks or options available to the customer service assistant, e.g., telemarketer, based on how the call is going. In this regard, if the call made or received is for or relates to a prospective mortgagor or mortgage refinance candidate, the processing device 34 is configured to cause the image 108e, “Pull Credit Report” to be shown on the display 110 of display key 32 shown in FIG. 4 enabling the customer service specialist to call up the credit report of the caller via execution of a software script or the like that transmits the pertinent caller data, e.g., name, social security number, address, etc. to an online credit report service that makes third party credit reports available to a subscriber over the Internet for a fee.

Thereafter, based on the nature of the very next call made or received, the display 110 of this display key 32 along with at least a plurality of other display keys 32 preferably changes to show selections that correspond to the call being made or received. For example, where the next call made or received after the mortgage or refinance related call discussed above is completed, the next call is to or from a person whose business is completely unrelated to that of the previous call. In this regard, where such a call relates to a loan servicing client, the person whose loan is being serviced by that client that is the object of the telephone call automatically causes a list of options or tasks that can be carried out on at least a plurality and preferably each display of each display key 32. For example, where one of the options displayed on one of the display keys 32 recites “Retrieve Payment History,” (not shown) pressing this display key automatically executes a software script, subroutine, or program that retrieves the payment history of the caller so the customer service representative on the phone with the caller can more quickly, efficiently and accurately help the caller.

Such a display keyboard can also be of benefit for everyday computer users. For example, in one preferred method of operation, a program, such as an API or Active X control run on the personal computer of a computer user browsing the Internet screening module or filter the current web page for corresponding code that invokes a change of the displays of one or more of the display keys 32 of the browsing computer. In addition, key display image data is also downloadable from the web page or a different web page once the screening module or filter detects a flag, e.g. certain code or the like, embedded in the currently browsed web page for being read and then shown on a display of a display key 32.

For example, as a person browsing the Internet using a computer 36 equipped with a display keyboard 38 browses a web page of a website that is embedded with display keyboard affecting code, such as XML, HTML, PERL, Active X, or the like, software such as in the form of a thread of a script, software module, subroutine, program, API or the like, detects the display keyboard affecting code and either executes it or carries out a series of steps based on the code. In this regard, the resultant execution causes the display 110 of at least one display key 32 to display an image or change the displayed image to one based on the embedded display keyboard affecting code. For example, as is shown in FIG. 5, where the embedded web page display keyboard affecting code is advertising related, it preferably causes the logo, name, and/or advertising slogan(s) to be displayed as an image 108f on the display 110 of at least one of the display keys 32 of the display keyboard 38 that is linked to the computer 36 connected to that web page. Thereafter, should the person press this display key 32, it will carry out a task that relates to the business of the company associated with the displayed logo, name and/or advertising slogan(s). In one preferred implementation of such a method, pressing the corresponding display key 32 causes the browser to redirect to the website of the company associated with the displayed logo, name, and/or advertising slogan image 108f. Revenue can be derived based on how many different computers equipped with a display keyboard 38 execute the embedded web page code and cause a display key 32 to change its image to that of the desired advertising or promotional image 108f as well as how many times an actual user actually presses or otherwise engages the display key 32 showing the corresponding advertising or promotional image 108f.

In like manner, software, such as a thread or the like, operating on a computer equipped with such a display keyboard 38 can remotely connect with a remotely located computer, such as a server or other computer with which it connects via a network, such as the Internet or the like, to obtain one or more images to be displayed on display keys 32 depending on whether it is subscription based, advertising based, web content based or based on another revenue generating business model. For example, purchasers of a new computer equipped with a display keyboard will benefit from pre-installed software that loads and displays images on the display keys 32 that relate to quickly obtaining customer assistance, such as by directing the purchaser to a customer support website when the corresponding “customer support” related labeled display key 32 is pressed, a site for downloading useful software to which the purchaser will be directed when the display key 32 showing a related message, logo or image is displayed, running a particular program, such as a program which automatically performs a self-diagnostic routine on the computer once the display key 32 displaying a related “run diagnostics” image (not shown) is pressed. Other functions, tasks and options can also be implemented in like manner.

A display keyboard equipped data processing device can also benefit from implementing a method of the invention where process, assembly line, logistical status, financial, production or other type of business related information or data is being monitored on an ongoing basis, preferably including in real time, whether the display keyboard equipped processing device 34, e.g., data processing device, is located onsite or remotely such that the desired data being monitored is delivered to the device 34 over a network or the like. FIG. 3 illustrates display keys 32a-32d each showing a different image that relates to a different type of data or information being provided to it from the plant, office, or other data or other information source. For example, the display 110 of display key 32a is depicted as displaying a temperature or angle related image, e.g. “180°” that a person monitoring can immediately press the display key 32a to carry out some action should circumstances dictate. For example, where a threshold or threshold range is exceeded or not met, the color of the displayed image 108a related to temperature or angle data received by the processing device 34 can change and/or it can begin flashing to get the attention of the monitoring person.

Similarly, display key image 108b shown on display key 32b is representative of the status of a device being monitored, which for the purposes of this example is a valve as indicated by the valve schematic image 108b shown. The image can change, e.g., animate as needed to show changes in the status of the device being monitored. For example, where the valve needs to be adjusted, closed or opened, something like that previously mentioned can be carried out to make the image get the attention of the monitoring person. As is discussed in more detail herein, one preferred embodiment of a display key constructed in accordance with the invention includes a transducer, preferably one capable of emitting sound, such that the particular display key 32b can also be activated to cause it to emit a sound alone or in addition to changing brightness, color or image flashing in order to try and get the attention of the monitoring person.

Similar image delivery, monitoring and task execution methods are implemented with regard to the dynamic bar graph image 108c shown on the display 110 of display key 32c as well as for the dynamically changeable meter image 108d shown on the display of display key 32d.

FIG. 6 illustrates another preferred embodiment of a display keycap 98′ that has a protective translucent or clear window 106 that preferably is integrally formed, such as by molding or the like, such that the display keycap 98′ is of one-piece and unitary construction. Where the window 106 and rest of the display keycap 98′ are made of the same material and have substantially the same optical transmissibility characteristics such that the window along with the rest of the display keycap 98′ is translucent, if not substantially transparent, the display keycap 98′ preferably can be quickly and economically molded so as to produce a display keycap 98′ of one-piece, unitary and homogenous construction. The display 110 depicted in phantom in FIG. 6 as underlying the display keycap window 106 illustrates an image 108g of a capital letter “T” to show its applicability to alphanumeric and language display keyboard and display keypad applications. However, virtually any other type, shade and style of character, icon, symbol, picture, graphic or the like can be readily shown on the display 110 if desired.

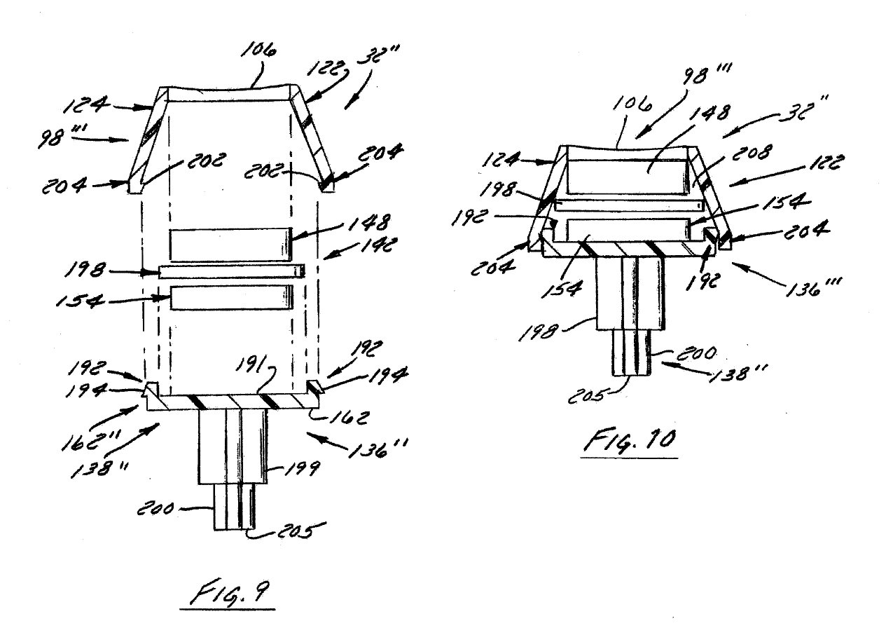

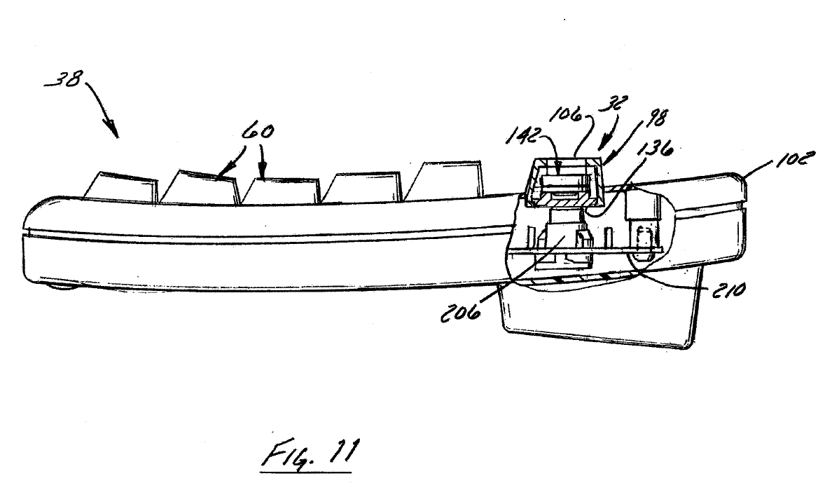

This display keycap 98′ differs from the display keycap 98 shown in FIGS. 3-5 in that it lacks the tapered sidewalls 122 and 124 that helps the corresponding display key 32 constructed of this display keycap 98 to achieve a desirably compact and low profile personal keyboard key shape while still being equipped with a key-top disposed display 110. In this additional preferred display keycap embodiment shown in FIGS. 6-8, the sidewalls 122′ and 124′, the front wall 128 and the rear wall 130 of the display keycap 98′ preferably imparts it with a generally rectangular cross sectional shape. As is depicted in FIGS. 7 and 8, one or both of the front wall 128 and rear wall 130 of display keycap 98′ can be slightly outwardly flared or tapered, preferably to facilitate assembly to a display key base 136 that is equipped with a downwardly extending switch-engaging plunger 138. In one preferred embodiment, the front wall 128 and the rear wall 130 of display keycap 98′ are inwardly tapered with angular extents similar to those of front wall 128 and/or rear wall 130 of display keycap 98. Each sidewall 122′ and 124′ extends generally perpendicularly downwardly from the display keycap top wall 104.

FIG. 7 illustrates a preferred embodiment of a display key assembly 140 that includes display keycap 98′ and display key base 136 that assemble together sandwiching between them an onboard key display assembly 142. The display assembly 142 includes a display 110 that is drivable via electricity or the like in a manner that permits images, such as images 108a-108f in FIGS. 3-6, to be controllably formed and displayed thereon. Each image 108 preferably is displayed in a visually perceptible form producing indicia that can be seen by a person, e.g., a user, viewing the display 110 of that particular display key 32.

The display 110 is a image forming device 144 that includes an LED, an LCD, or another type of image forming device that can be of active construction and operation such that the image former 144 includes an emitter of light that is used to form the desired image and that can be of passive construction and operation that includes a light manipulator that uses light from another source to form the desired image. In a preferred embodiment, the image former 144 is an LCD display 146 having at least a 20×20 dot or pixel configuration encompassing a viewing area of at least 8 millimeters (about 0.31 inch) by 6.5 millimeters (about 0.256 inch) and a viewing area of at least about 6 millimeters (about 0.23 inch) by about 6 millimeters (about 0.23 inch). In a presently preferred embodiment, the image former 144 is a square or generally rectangular LCD 146 of FSTN construction that has a configuration of at least 30×30 dots or pixels. In a still further preferred embodiment, the image former 144 is a square or generally rectangular LCD 146 having a configuration that is at least 40×40 dots or pixels and which preferably also is of FSTN construction.

The LCD 146 preferably is part of a display module 148 that can and preferably does include an integral display mount, such as a circuit board or the like, to which an electrical cable 150 attaches for providing electricity to power the LCD 146 as well to enable digital LCD drive data signals to be communicated to the LCD 146. The cable 150 preferably is a ribbon cable or the like that has at least a plurality of pairs of conductors, e.g. insulated wires, that each conduct electricity to the LCD display either to power it or to drive it.

One or both ends of the cable 150 can be equipped with a connector 152 for enabling it to be plugged into a complementary connector (not shown) onboard either the display module 148 or an onboard circuit board 154 that underlies the display module 148 serving as a spacer for the display module 148 when assembly of the display key assembly 140 is completed. In one preferred embodiment, the circuit board 154 includes a display driver 156 (generically depicted in FIG. 7), preferably an LCD driver integrated circuit or the like, that uses signals received from the display keyboard, display keypad and/or data processing device to address the desired dots or pixels of the LCD 146 to form the desired key display image. Electric power is also provided to supply an operating voltage and logic supply voltage to the display module 148.

Another cable 168 that preferably also is a ribbon cable extends from the onboard display driver circuit board 154 to the display keyboard, display keypad or to the data processing device to which the display key 32 is ultimately in communication with. The free end of the cable 168 preferably has a connector 170 that plugs into a socket on the keyboard, keypad or data processing device. Although not shown in FIG. 7, the inner surface of adjacent display keycap wall 130 and/or the outer surface of an adjacent part of the display key base skirt 164 can be configured with a channel, bore or other passageway to provide a cable passage enabling cable 168 to be plugged into the display keyboard, keypad and/or data processing device.

Where the display module 148 is equipped with an onboard backlight (not shown in FIG. 7), such as in the case where an LCD display is used, it may be necessary to supply additional electrical power to the module to power the backlight. Where a backlight is needed but not provided onboard the display module 148, the onboard display driver circuit board 154 can be equipped with a backlight, such as the backlight 158 schematically depicted in phantom in FIG. 7. Such a backlight 158 is a lamp preferably in the form of an LED because of the rather tight packaging constraints a personal computer keyboard key size imposes on the configuration of a display key 32 configured for such small display key switch form factor applications. Where such constraints are less of a factor or overcome in the future such as by technical innovation, other types of backlighting, such as electroluminescence panel backlighting (not shown) or cold cathode fluorescent backlighting (not shown), can be used. Such a backlight can also be adapted in a similar manner for use with other display key assemblies disclosed herein.

As previously mentioned, if desired, a display key assembly 140 for a display key 32 constructed in accordance with the invention can be equipped with a transducer, such as the transducer 160 schematically depicted in FIG. 7 as being mounted to the onboard display driver circuit board 154. Where sound is desired to be produced, the transducer 160 preferably is a sound transducer that outputs sound when supplied with an appropriate electrical signal input. In one preferred embodiment, the transducer 160 is a sound transducer of mini-audio construction mini-tone transducer or mini-sound generator that preferably is small enough in view of the aforementioned tight packaging constraints. In another preferred embodiment, the transducer 160 preferably also is a sound transducer that is of piezoelectric construction. In a still further embodiment, the transducer 160 is a magnetic or electromagnetic sound transducer that also is of compact construction. Other transducers for other applications apart from sound generation can also be disposed onboard a display key or display key switch assembly constructed in accordance with the invention. Such a transducer can also be adapted in a similar manner for use with other display key assemblies disclosed herein.

Although not shown, the onboard circuit board 154 can also be configured with a display controller, such as an LCD display controller. Such a controller can be mounted on the circuit board as a component separate from or combined with the display driver 156.

The display key base 136 includes a platform 162 upon which the components of the display assembly 142, including the display module 148, circuit board 154, etc. can be seated, carried or otherwise supported. Bounding its periphery is a down-turned skirt 164 that engages with the inner surfaces of the walls 122′, 124′, 128 and 130 of display keycap 98′ when the display keycap 98′ is assembled to the key base 136 in a manner ensuring positive engagement therebetween.

The plunger 138 is an elongate tubular or generally cylindrical extension 166 that extends outwardly from the underside of the platform 162, projecting beyond the skirt 164 with the plunger 138 receivable in a bore or socket of an upraised key switch plunger receiving receptacle (not shown in FIGS. 7 and 8) whose housing preferably is anchored to some portion of the display keyboard, such as its housing or frame. Although not shown in FIGS. 7 and 8, the plunger 138 is received in a reciprocating manner in a plunger guiding chimney of a personal computer keyboard key switch that is part of an outer key switch housing that is fixed to part of the keyboard and which bears against a yieldable electrical key switch contact carrying dome of the construction disclosed in U.S. Pat. No. 5,386,091, the entire disclosure of which is hereby expressly incorporated herein by reference when the display keycap 98′ is pressed to make key switch contact. The plunger and the like of the display key assembly 140 shown in FIGS. 7 and 8 are also adaptable for use with the bore and piston plunger receiver of the key switch assembly disclosed in U.S. Pat. No. 4,939,324, the entire disclosure of which is hereby expressly incorporated herein by reference. The plunger 138 and components of the display key assembly 140 shown in FIGS. 7 and 8 is also well suited for use with the key switch assembly disclosed in U.S. Pat. No. 6,057,522, the entire disclosure of which is hereby expressly incorporated herein by reference.

The display key assembly 140′ shown in FIG. 8 differs from that depicted in FIG. 7 as its display keycap 98″ includes a plurality of canted LCD display module capturing tabs 172 that capture and hold the display module 148 in place inside the display keycap 98″ with its LCD 146 facing toward and located very close to the display keycap window 106 in the manner depicted in phantom in FIG. 8. When the display module 148 is urged against the tabs 172 during assembly, its outer edges cam along the inclined tab surfaces 174 until the display 110 and/or display module 148 snaps into a pocket 176 defined between the tabs 172 and the display keycap window 106.

To facilitate assembly of the display keycap 98″ to the key base 136′, the skirt 164 of the base 136 is equipped with outwardly projecting detent tabs 178 that are each received in detent tab-receiving pockets 180 formed in an interior surface of the walls 128 and 130 of the display keycap 98″. When the display keycap 98″ is assembled to the base 136 the detent tabs 178 snap into a corresponding tab-receiving pocket 180 thereby opposing and preferably preventing disassembly of the display key 32″ produced as a result.

To eliminate a cable run exteriorly of the display key or display key assembly, source cable 168 has been eliminated and replaced with an intermediate cable 182 that extends through a bore or the like in the platform 162 of the base 136 into an interior passageway 184 within the plunger 138′. A plurality of pairs of individual wiring runs 186 extend along the plunger passageway 184 until each wiring run terminates at or adjacent the axial plunger end in a contact 188 that preferably is disposed exteriorly of the plunger tube 166 and spaced from one another about the outer peripheral axial end edge of the plunger 138′.

Each electrical contact 188 is located along this periphery relative to a plunger anti-rotation key 190 disposed along one side of the plunger 138′ that rides in a slot (or vice versa) in the key switch housing socket (not shown) in which the plunger 138′ is received. Because plunger rotation is prevented, each wiring contact 188 slidably contacts a corresponding contact (not shown) of a supply wire (not shown) carried by the key switch housing and which preferably is disposed in the key switch housing socket. During reciprocating plunger movement that occurs during display key switch operation, electrical power and image-related data are transmitted via contacts 188, along wiring runs 186, through intermediate cable 182, to the onboard driver circuit board 154, and ultimately to the display module 148 where a desired image is produced by its LCD 146 as a result.

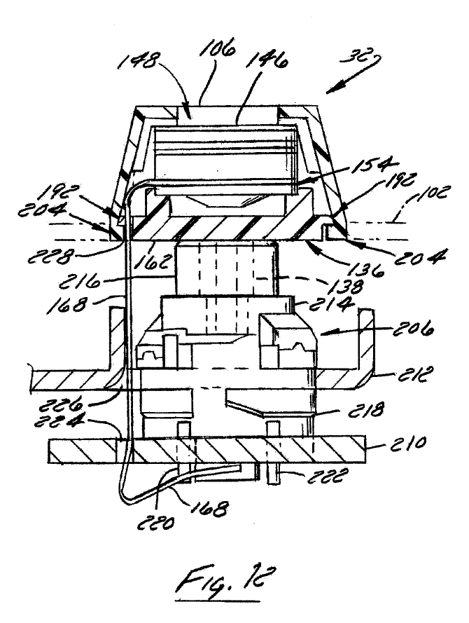

FIGS. 9 and 10 illustrate another preferred embodiment of a display key 32″ constructed in accordance with the present invention. The display assembly 142′ includes circuit board 154 and display module 148 spaced apart by a backlight diffuser 198 that can also serve as a spacer 197, such as in instances where no backlight is employed. The diffuser 198 helps more evenly spread out light from a backlight (not shown in FIGS. 9 and 10) along the backside of the display module 148. The diffuser 198 underlies the display modules 148. The diffuser 198 can be a wafer of a translucent or transparent plastic, glass or the like.

The display key base 136″ preferably is of one-piece, unitary and homogenous molded plastic construction having integrally formed features that facilitate fast and easy snap together assembly. Extending downwardly from the platform 162 of the base 136″ is a plunger 138″ of generally “+” or cross-shaped cross section. The plunger 138″ has a stem 199 adjacent the platform 162 from which a narrower or necked down switch-actuating plunger segment 200 extends. In the preferred plunger embodiment shown in FIGS. 9 and 10, the free end 205 of the switch-actuating plunger segment 200 functions as a key switch actuator when part of a key switch assembly (not shown).

The key base 136″ includes an integral display circuit board supporting platform 162″ that is bounded along at least two opposed sides by at least one pair of upraised and generally parallel assembly-facilitating flanges 192 forming a seat 191 in which the onboard display driver circuit board 154 is received. Each flange 192 also has an integrally formed outwardly extending snap hook 194 of a snap 196 that preferably is a cantilever-type snap. Depending on the upraised flange height that is desired, the flanges 192 can also serve as a seat for the entire display assembly 142″. The resultant seat 191 preferably helps orient and locate part or all of the display assembly 142, including the display 110, such that its angular orientation and distance from the key cap top wall 104 preferably is consistent from display key to display key.

The display keycap 98′″ preferably is also of one-piece and unitary molded plastic construction that can also be of one-piece, unitary and homogenous molded plastic construction as well. At least one pair of its opposed walls, such as preferably sidewalls 122 and 124, each includes an inwardly extending snap hook 202 that is integrally formed during molding. Each snap hook 202 extends along at least a portion of the inner bottom edge of each sidewall 122 and 124. Each sidewall 122 and 124, along with its corresponding integral snap hook 202, defines another snap 204 that preferably also is an integral cantilever-type snap.

During assembly, the display assembly 142″ is placed or otherwise disposed between the key base 136″ and the display keycap 98′″ such that at least the display driver circuit board 154 seats. Applied force causes relative movement between the base 136′″ and keycap 98′″ to bring them together into engagement until the snap hooks 202 of each keycap wall 122 and 124 cam along and over corresponding snap hooks 194 such that a snap fit is created therebetween that creates positive engagement that keeps the components securely assembled together. This fast, simple and economical snap-together display key assembly 140″ securely retains the components of the display assembly 142″ in an internal cavity 208 (FIG. 10) defined between the keycap 98′″ and key base” while maintaining their desired proper location and orientation for stable and effective operation.

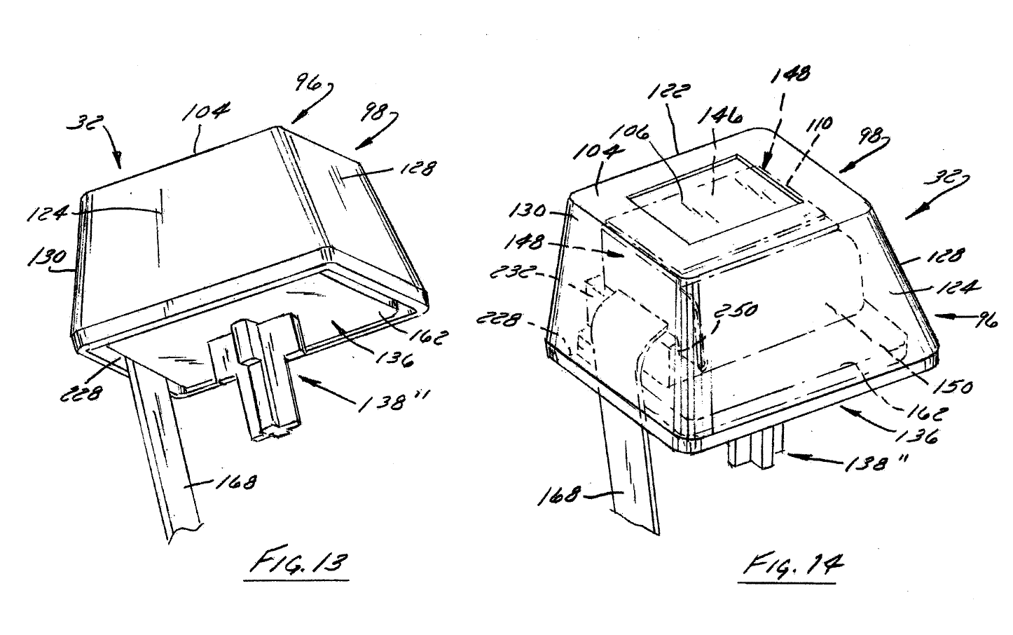

FIG. 11 illustrates the display keyboard 38 of FIGS. 1 and 2 with its keyboard housing 102 cutaway to depict a display key 32 of the invention mounted to a key switch assembly 206 that is, in turn, anchored to an internal keyboard frame 210 that can be a circuit board, such as a keyboard controller circuit board that is anchored to part of the keyboard housing 102. FIG. 12 illustrates another preferred embodiment where the key switch assembly 206 is also anchored to a internally disposed keyboard frame 212 that is separate from the keyboard controller circuit board 210 and housing 102. In some instances, it is recognized that it can be mounted to the circuit board 210 and keyboard housing 102, particularly where the keyboard lacks a separate frame of the type depicted in FIG. 12.

As is shown in phantom in FIG. 12, the plunger 138 of the display key 32 is reciprocably received in a complementary socket or receptacle (not shown) formed in the key switch assembly 206. The key switch assembly 206 has an outer housing 214 that is mounted by physical attachment to the internal keyboard frame 212. The plunger accepting socket is disposed in an upwardly extending pedestal 216 of the housing 214. The key switch housing 214 can be physically mounted using one or more fasteners, such as rivets, screws, bolts or the like, or can use another means of attachment.

A bottom section 218 of the key switch housing 214 is mounted to the keyboard circuit board 210 by soldering or otherwise electrically attaching to the circuit board a plurality of switch contacts 220 and 222 that extend from the key switch housing 214. Each key switch contact 220 and 222 help define a switch circuit that is closed when the display key 32 is pressed downwardly a sufficient distance until its plunger 138 bears against a part of a switch arrangement disposed within the key switch housing 214 actuating the switch of the switch arrangement. Examples of exemplary and suitable switch arrangements along with exemplary and suitable key switch assemblies are shown and disclosed in aforementioned U.S. Pat. Nos. 6,057,522, 5,386,091, and 4,939,324, the entire disclosures of each of which is incorporated by reference herein. Other key switch arrangements can also be used, which is an advantage of the display key 32 of the present invention in that it can utilize any kind of pre-existing plunger configuration such that it can be easily adapted for use with just about any kind of a key switch assembly, known or otherwise.

As is also depicted in FIG. 12, cable 168 is attached to part of the keyboard circuit board 210 via connector 170. The cable 168 passes through a channel 224 in the circuit board 210, through a passageway 226 formed in the keyboard frame 212, and through a cable conduit 228 integrally formed in the display key base platform 162. The cable 168 connects to the display driver circuit board 154 onboard the display key 32. If desired, it can directly connect to the display module 148, such as where no onboard display driver circuit board 154 is used.

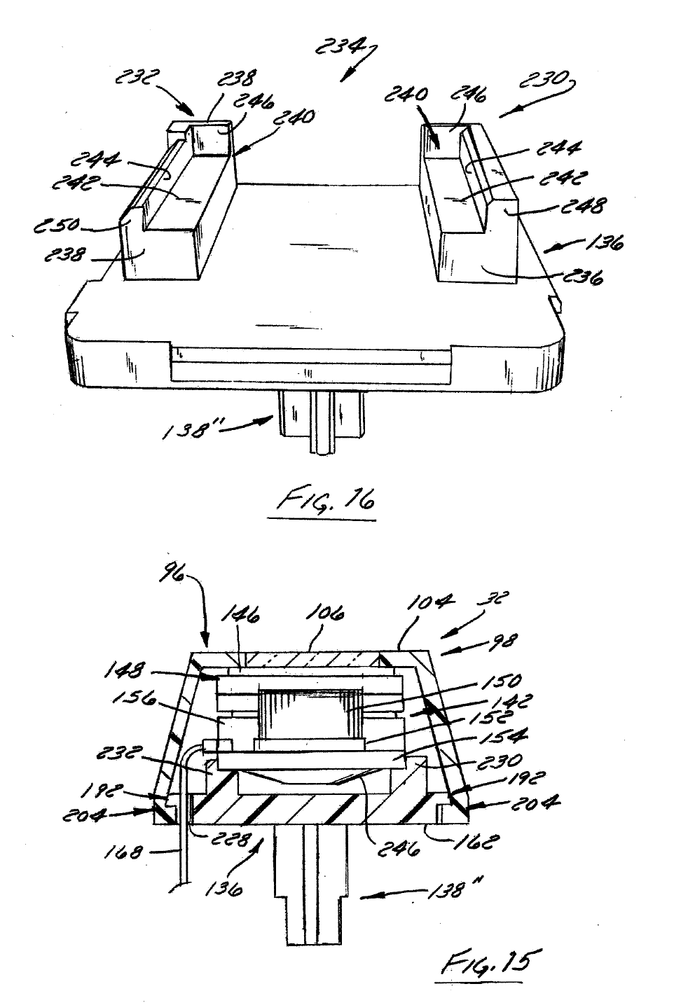

FIGS. 13-15 illustrate a preferred embodiment of a display key 32 in more detail after assembly has been completed. The display keycap 98 overlies and encircles the outer periphery of the circuit board seating platform 162 of the display key base 136 preferably engaging the key base 136 along this region of overlap. The cabling conduit 228′ is disposed between an inner surface of a display keycap sidewall and the outer edge of part of the platform 162 of the key base 136.

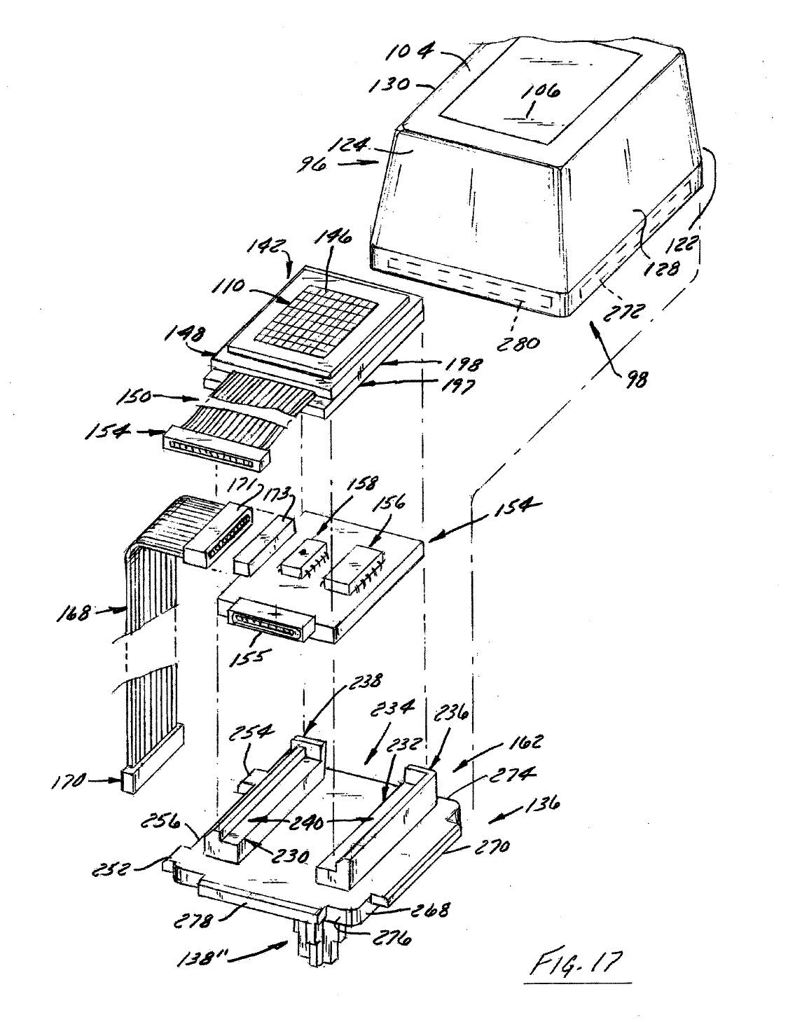

As is depicted in FIGS. 15 and 16, the platform 162 of the key base 136 of the display key assembly 140 depicted in FIGS. 13 and 14 includes a pair of spaced apart and upraised seats 230 and 232 that cooperate to form a display assembly receiving cradle 234 in which at least the display driver circuit board 154 if the display assembly 142 seats during assembly. Each seat 230 and 232 preferably is an elongate support 236 and 238 that has a generally L-shaped cradle pocket 240 formed in it in which at least a portion of the display assembly 142 is disposed when seated in the cradle 234. Each cradle pocket 240 is defined by a land 242 upon which part of the bottom of the key display assembly rests when seated, an upraised side edge abutment 244 against which part of one side or side edge can bear when seated, and an upraised end edge abutment 246 against which an end edge can bear when seated. The side edge abutments 244 are respectively defined by an upwardly extending lip 248 and 250 formed in the corresponding support 236 and 238. The side edge abutment 244 of both seats 230 and 232 preferably also advantageously functions as a seating guide to help facilitate key display assembly seating during display keycap assembly and, of course, help constrain or bound that part of the key display assembly that it seats to help ensure it is properly angularly located or oriented within display key 32. The same preferably is also true of the end edge abutments 246.

The height of the lands 242 preferably helps ensure proper positioning of the display assembly 142 within the display keycap housing 96 so the LCD 146 ends up being generally centered within the display key 32 and located adjacent the top of the display keycap 98 when assembly is finished. For example, in the preferred embodiment shown in FIG. 15, it ultimately helps locate the LCD 146 so it is disposed immediately adjacent to and underlying keycap window 106. Its spacer function can also be used to ensure space exists between the display key base platform 162 and the bottom of the seated part of the display assembly 142 where clearance space is needed or otherwise desired to accommodate cabling (not shown) as well any component 246 (FIG. 15) of the assembly 142 that projects outwardly and downwardly toward the platform 162.

Referring additionally to FIG. 17, the display key base 136 has a plurality of pairs of outwardly extending assembly tabs disposed about its periphery which therefore means they are also spaced about the periphery of the platform 162. Such assembly tabs preferably are disposed along at least three side edges of the base 136 and platform 162. If desired, such as depending on the application, type of data input device, e.g., keyboard, keypad, etc., tabs can be employed along all four side edges.

A plurality of outwardly extending and spaced part assembly tabs 252 and 254 (FIG. 17) are disposed along a rear side edge 256 of the display key base platform 162. In the preferred embodiment depicted in FIGS. 16 and 17, the rear side platform edge 256 has a pair of such tabs 252 and 254, each of which engages a bottom portion of the rear wall 130 of the display keycap housing 96, only a fragmentary portion of which is shown in FIG. 16. Each tab 252 and 254 is received in a corresponding tab-receiving pocket 258 and 260 formed in an interior surface 262 of the keycap housing wall 130. The pockets 258 and 260 are spaced apart substantially the same as tabs 252 and 254 so both tabs 252 and 254 can be received in its corresponding pocket 258 and 260 at substantially the same time during display key assembly.

Preferably, the tabs 252 and 254 are spaced apart a sufficient distance to permit routing of the display assembly connector cable 168 between them, such as in the manner depicted in FIGS. 13-14 and 17. To provide additional clearance for the cable 168, the interior bottom edge surface of the display keycap housing wall 130 preferably has an outward bevel 264 or other type of clearance recess. If desired, tolerances between the display keycap 98 and base 136 can be selected to help accommodate cable passage, preferably in addition to the aforementioned arrangements for doing so. The bevel 264 can extend the entire length of the wall 130, but preferably need only extend along a lesser extent of the wall 130, such as where cable routing occurs or is likely. To further help facilitate ease of assembly and cable routing, a rear portion of the cradle support 238 adjacent the tabs 252 and 254 preferably also has such a clearance bevel 266 formed along an outer upper edge of its lip 250.

Each tab 252 and 254 of the base 136 preferably functions as a hook that positively engages the display keycap housing 96 when the housing 96 is being snapped onto the key base 136 during assembly. After assembly is completed, the keycap housing 96 is positively retained on the base 136, such as in the manner shown in FIGS. 13 and 14. Preferably, each tab-receiving pocket 258 and 260 formed in the interior surface of the keycap housing rear wall 130 is formed with an undercut or sharp angle that produces more positive engagement between the keycap housing wall 130 and the tab 252 and 254 when received in their respective pocket 258 and 260. As a result, snap-together assembly produces positive engagement between these tabs 252 and 254 and the keycap housing rear wall 130 thereby preventing disassembly from undesirably inadvertently occurring.

The front platform edge 268 also has at least one outwardly extending assembly tab 270. Where only a single tab 270 is employed, the tab 270 preferably has a length or extent that is greater than half the length of the platform edge 268 from which it outwardly extends. This produces increased engagement between the keycap housing 96 and the key base 136 during assembly, which also facilitates positive engagement and assembly of the keycap housing 96 to the base 136. The interior surface of the front keycap housing sidewall 128 preferably has a single elongate tab receiving pocket 272 (shown in phantom in FIG. 17) of generally rectangular or oblong construction for receiving the elongate tab 270 therein during snap-together assembly of the housing 96 to the base 136.

At least one of the side platform edges 274 and/or 276 are equipped with at least one assembly tab 278 that preferably is of elongate construction and has a configuration substantially the same as or like that of tab 270. To receive the tab in like manner producing positive engagement between the corresponding keycap housing sidewall and base, the interior surface of the corresponding housing sidewall also has a tab-receiving pocket 280 (shown in phantom in FIG. 17) formed in it. In the preferred embodiment shown in FIGS. 16 and 17, only one side edge 276 is equipped with such a tab 278 and only one sidewall 124 is equipped with a tab receiver 280.

With continued reference to FIG. 17, in assembly, the onboard circuit board 154 is placed in the seats 230 and 232 of cradle 234, preferably with any backlight 158 with which it is equipped facing away therefrom. The display module 148 is placed over the circuit board 154, which can be done prior to seating the circuit board in the cradle 234 of the display key base 136. Where the circuit board 154 is equipped with a backlight 158, the display assembly 142 preferably includes a diffuser 198 that can also serve as a spacer 197 between the display module 148 and circuit board 154. Where such a spacer 197 is used, including with or without a backlight being present, it preferably electrically insulates and/or isolates the display module 148 and circuit board 154.

The connector 154 of the display module ribbon cable 150 is plugged into a corresponding complementary socket or receptacle 155 that is mounted to the circuit board 154. The primary power and data delivery ribbon cable 168 can be equipped with a connector 171 at its end that connects to the circuit board 154. If not soldered or otherwise fixed to the circuit board 154, the connector 171 of cable 168 preferably plugs into a socket or receptacle 173 that is fixed to the circuit board 154.

The cable 168 is routed between display key base assembly tabs 254 and 256 before the display keycap housing 96 is manipulated to put it on top of the display assembly 142 and so it overlies the display key base 136. Thereafter, relative movement and applied force causes the beveled assembly tabs 254, 256, 270 and 278 to elastically deform or otherwise spread apart contacting portions of display keycap walls 124, 128, and 130 sufficiently so as to allow the tabs 254, 256, 270 and 278 to snap into their respective tab receiving pockets 258, 260, 272 and 280 in display keycap walls 124, 128, and 130, completing assembly of a display key 32.

The connector 170 at the other end of cable 168 is preferably thereafter plugged into a similar complementary socket or receptacle (not shown) that is fixed to and in electrical communication with a data input device controller circuit board, e.g., keyboard controller board 210 (FIGS. 11 and 12). This preferably is done at or about the same time that the display key plunger 138″ of the assembled display key 32 is inserted into a complementary socket or receptacle of a key switch assembly of the data input device, e.g. display keyboard 38. In a preferred method of assembly, cable connector 170 is plugged into its corresponding socket or receptacle before the display key plunger 138″ as assembled to the key switch assembly.

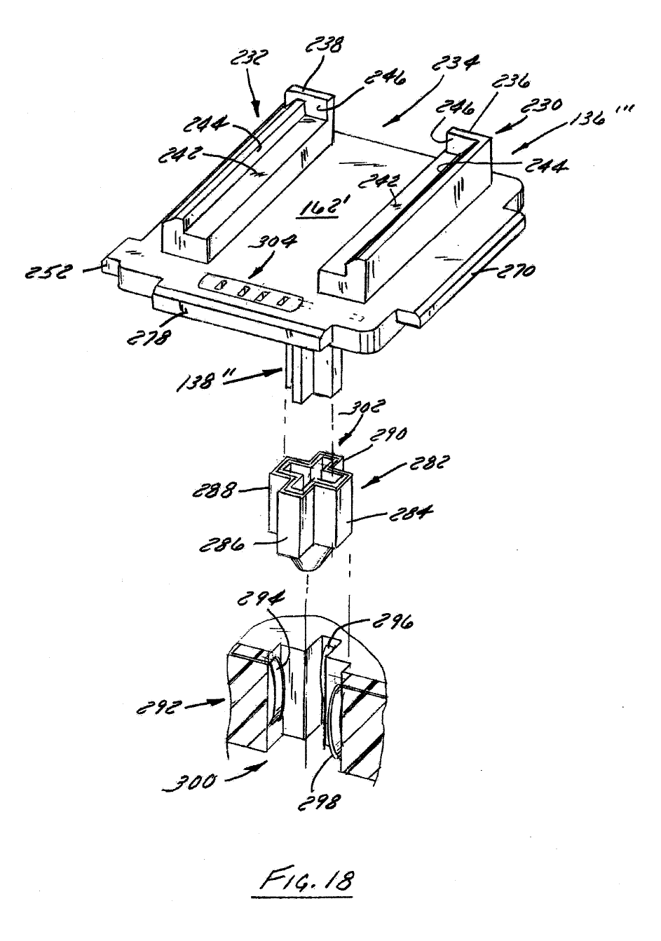

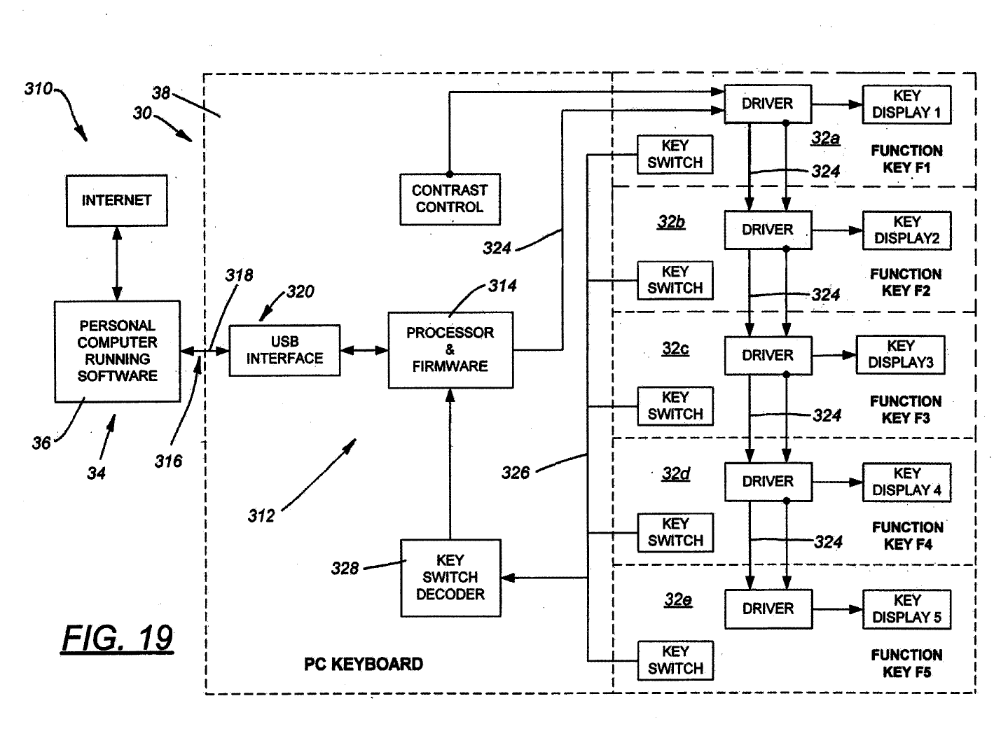

FIG. 18 illustrates another preferred embodiment of a display keycap base 136′″ that includes a contactor coupling sleeve 282 that telescopes over the plunger 138″ to enable a plurality of pairs of electrical links or connections to be made between the input device controller circuit board and various electrical components disposed onboard a display key 132 made with the display keycap base 136″. As a result, the need for cable 168 is eliminated also thereby eliminating the requirement of the separate assembly step of plugging the cable 168 into a socket or receptacle in communication with a controller board of the data input device 30, e.g., display keyboard 38 and/or data processing device 34, e.g., computer 36.

External surfaces of the coupling sleeve 282 include a plurality of pairs of electrical contacts 284, 286, 288, and 290 that permit electrical power to be delivered to a display module 148 disposed onboard the display key, such as to power it, as well as to permit communication of data signals, such as causing the onboard display to form a desired image. The key switch arrangement 292 that receives the coupling sleeve carrying plunger 138″ of the display key has been modified as shown in FIG. 18 to include a plurality of pairs of outwardly extending contact springs 294, 296, and 298 disposed in the plunger socket 300 that each makes electrical contact with a corresponding one of the contacts 284, 286, 288, and 290 of the contactor coupling sleeve 282 when the display key plunger 138″ is inserted into the socket 300.

Although not shown in FIG. 18, the end 302 of each contact 284, 286, 288, and 290 of the contactor coupling sleeve 282 that is located adjacent the bottom of the base platform 162 is received in a complementarily shaped socket (not shown) equipped with electrical contacts (not shown) that each make an electrical connection with a corresponding one of the contacts 284, 286, 288, and 290 of the contactor coupling sleeve 282. Each of these contacts (not shown) are carried by the display key base 136 and each is linked to a corresponding pin or the like of the cable connector socket 304 that is integrally disposed in the top surface of the platform 162′. The connector 154 of cable 150 preferably plugs into this socket 304 to communicate power and control signals to the display module 148 and/or display driver 156, if a display driver is disposed onboard the display key 32.

Modifications can be made to the contactor coupling sleeve 282 without departing from the scope of the invention. For example, the plunger 138″ and the coupling sleeve 282 could be configured with a different cross-sectional contour thereby increasing the number of contacts from four to more than four.

Other modifications are also possible. For example, the contact arrangement of the key switch plunger socket 300 is adaptable for use with the multiple contact carrying plunger 138′ of the display key base 136′ depicted in FIG. 8.

FIG. 19 schematically depicts a data input device system 310 that includes a controller arrangement 312 that preferably is implemented in software or firmware by processor 314 by which sets of image data for a plurality of pairs of display function keys 32a, 32b, 32c, 32d and 32e are communicated from the processing device 34, e.g., computer 36, via a bus 316 that preferably is a USB bus 318 and interface 320 to the processor 314 of the data input device 30, e.g., display keyboard 38. The sets of key display image data for a plurality of display keys 32a-32e is delivered from the processing device 34 using the USB link 318 and interface 320 to the processor 314. The sequence or order of the sets of key display image data preferably determines which one of the display keys 32a-32e receives which set of image data to control which display key displays which image. It can be predetermined with set order received by the processor 314 determining which set of image data will provided to which particular display key 32a-32f.

If desired, additional data can be provided, such as via the processing device 34, which the processor 314 can use to assign each received set of image data to a specific display key 32a-32f. If so, the processor 314 preferably is configured, such as via firmware or the like, to slot, order or reorder the received sets of image data so image data sets will be serially delivered in the desired order to the display keys 32a-32f when the processor 314 communicates the image date via the serial bus to the display keys 32a-32e.

In a preferred method of operation, a plurality of sets of image data, I₁-I₅, is delivered to the processor 314. The processor 314, once ready to change the images being displayed on display keys 32a-32e, communicates the image data via a serial bus 324 such that set I₅ is slotted first to be delivered on the serial bus 324, I₄ is slotted next, I₃ is slotted after I₄ and so forth. Once the bus 324 is full such that a set of image data for each one of the display keys 32a-32f has been communicated serially on the bus 324 to the display keys, each display key 32a-32f receives the desired image data and thereafter displays the desired image associated with that image data. For example, a first image associated with first in queue image data set I₅ will be delivered first to bus 324 so it is received and displayed by display key 32e, a second image associated with second in queue image data set I₄ will be delivered second to bus 324 so it is received and displayed by display key 32d, a third image associated with first in queue image data set I₃ will be delivered third to bus 324 so it is received and displayed by display key 32c, a fourth image associated with first in queue image data set I₂ will be delivered fourth to bus 324 so it is received and displayed by display key 32b, and a fifth image associated with first in queue image data set I₁ will be delivered last to bus 324 so it is received and displayed by display key 32a.

In a further preferred method of display key use and operation, a display key 32a, 32b, 32c or 32d is pressed, it closes its associated keyswitch causing a signal to be communicated along a bus 326 to a key switch decoder 328 that preferably is of conventional construction and configuration. More specifically, a display keyboard constructed in accordance with the invention preferably uses a conventional keyboard keyswitch decoder and associated circuitry. The key code associated with the particular display key 32a, 32b, 32c, 32d or 32e that was pressed is communicated via bus 316 ultimately to the processing device. In the preferred embodiment shown in FIG. 19, the key code, e.g. ASCII code, corresponding to the pressed display key 32a, 32b, 32c, 32d or 32e is communicated to the processor, which in turn, communicates it to the processing device. The processing device 34 thereafter interprets the received key code and then executes the task or function associated with the code. Where the data input device 30 is also equipped with non-display keys, the same key switch decoder arrangement is advantageously employed such that only a single key switch decoder 328 handles key switch signals received from display keys and non-display keys.

In another preferred embodiment, one or more display keys 32 constructed in accordance with the present invention can be used with the control unit and methods shown and described in commonly owned U.S. Pat. No. 6,798,359, the entire disclosure of which is hereby incorporated by reference herein.

It is also to be understood that, although the foregoing description and drawings describe and illustrate in detail one or more preferred embodiments of the present invention, to those skilled in the art to which the present invention relates the present disclosure will suggest many modifications and constructions as well as widely differing embodiments and applications without thereby departing from the spirit and scope of the invention.

It is claimed:

1. A configurable display-equipped key comprising a plurality of key housing components between which is disposed a display and a display driver for the display.

2. The configurable display-equipped key of claim 1 wherein one of the key housing components comprises a display key base that has a key switch actuating plunger extending therefrom and a keycap housing constructed and arranged to permit viewing of an image displayed by the display.

3. The configurable display-equipped key of claim 1 wherein one of the key housing components is a display key base comprised of an integrally formed display-locating seat.

4. The configurable display-equipped key of claim 1 wherein one of the key housing components comprises a hollow keycap and another one of the key housing components comprises a key base wherein the hollow keycap and key base are of snap-together construction so as to keep captive the display and display driver in a display key cavity formed by the hollow keycap and key base.

5. The configurable display-equipped key of claim 4 wherein the key base comprises a plunger of cross-shaped cross section or of generally cylindrical cross section and further comprising a conventional key switch assembly in which the plunger is reciprocably received.

6. The configurable display-equipped key of claim 5 further comprising a controller circuit board disposed off-board the display-equipped key and further comprising a ribbon cable extending from within the display key cavity to external of the display key cavity connecting the display disposed in the display key cavity to the controller circuit board.

7. The configurable display-equipped key of claim 1 wherein one of the key housing components is a display key base comprised of an integrally formed seat and the onboard display driver is mounted to an onboard circuit board that is received in the integral seat.

8. The configurable display-equipped key of claim 7 wherein the seat is formed of a plurality of spaced apart and upraised supports that each have a circuit board receiving land formed therein.

9. The configurable display-equipped key of claim 1 wherein one of the components comprises a keycap housing with integrally formed snaps each comprised of a snap hook and a key base with integrally formed snaps each comprised of a snap hook wherein the keycap housing and key base are of snap together construction with the onboard display and onboard driver capture therebetween when snapped together.

10. The configurable display-equipped key of claim 1 wherein each snap comprises a cantilever snap.

11. The configurable display-equipped key of claim 1 wherein one of the components comprises a keycap housing and a key base with one of the keycap housing and base having a plurality of tabs and the other one of the keycap housing and base having a plurality of snap receivers wherein snap fit engagement of the keycap housing with the base defines a display key having a cavity therein in which the display is disposed.

12. A configurable display-equipped key comprising a plurality of key housing components between which is disposed a display and a display driver for the display.

13. The configurable display-equipped key of claim 12 wherein one of the key housing components comprises a display key base that has a key switch actuating plunger extending therefrom and a keycap housing constructed and arranged to permit viewing of an image displayed by the display.

14. The configurable display-equipped key of claim 12 wherein one of the key housing components is a display key base comprised of an integrally formed display-locating seat.

15. The configurable display-equipped key of claim 1 wherein one of the key housing components comprises a hollow keycap and another one of the key housing components comprises a key base wherein the hollow keycap and key base are of snap-together construction so as to keep captive the display and display driver in a display key cavity formed by the hollow keycap and key base.

16. The configurable display-equipped key of claim 15 wherein the key base comprises a plunger of cross-shaped cross section or of generally cylindrical cross section and further comprising a conventional key switch assembly in which the plunger is reciprocably received.

17. The configurable display-equipped key of claim 16 further comprising a controller circuit board disposed off-board the display-equipped key and further comprising a ribbon cable extending from within the display key cavity to external of the display key cavity connecting the display disposed in the display key cavity to the controller circuit board.

18. The configurable display-equipped key of claim 12 wherein one of the key housing components is a display key base comprised of an integrally formed seat and the onboard display driver is mounted to an onboard circuit board that is received in the integral seat.

19. The configurable display-equipped key of claim 18 wherein the seat is formed of a plurality of spaced apart and upraised supports that each have a circuit board receiving land formed therein.

20. The configurable display-equipped key of claim 12 wherein one of the components comprises a keycap housing with integrally formed snaps each comprised of a snap hook and a key base with integrally formed snaps each comprised of a snap hook wherein the keycap housing and key base are of snap together construction with the onboard display and onboard driver capture therebetween when snapped together.

21. The configurable display-equipped key of claim 12 wherein each snap comprises a cantilever snap.

22. The configurable display-equipped key of claim 12 wherein one of the components comprises a keycap housing and a key base with one of the keycap housing and base having a plurality of tabs and the other one of the keycap housing and base having a plurality of snap receivers wherein snap fit engagement of the keycap housing with the base defines a display key having a cavity therein in which the display is disposed.
